(19) United States
(12) Patent Application Publication
(10) Pub. No.: US 2021/0223874 A1
(43) Pub. Date: Jul. 22, 2021

(54) TOUCH PEN

(71) Applicant: Samsung Display Co., Ltd., Yongin-si (KR)

(72) Inventors: Hyun Been HWANG, Yongin-si (KR); Seok Won JANG, Yongin-si (KR); Cheol Ho CHOI, Yongin-si (KR); Hirotsugu KISHIMOTO, Yongin-si (KR)

(21) Appl. No.: 17/001,928

(22) Filed: Aug. 25, 2020

(30) Foreign Application Priority Data
Jan. 20, 2020 (KR) 10-2020-0007544

(51) Int. Cl. G06F 3/0354

(52) U.S. Cl. CPC G06F 3/03545

(57) ABSTRACT

A touch pen for touching a display device to provide touch input information to the display device is provided. A touch pen includes a cover member; a touch member inside the cover member and including a touch tip, a coupling part, and a non-coupling part connecting the touch tip and the coupling part; and a holding member arranged to be fixed to an inner circumferential surface of the cover member and detachable from the coupling part according to a separation condition.

### CROSS-REFERENCE TO RELATED APPLICATION

This application claims priority to and the benefit of Korean Patent Application No. 10-2020-0007544, filed on Jan. 20, 2020 in the Korean Intellectual Property Office, the entire content of which is hereby incorporated by reference.

### BACKGROUND

### 1. Field

Aspects of embodiments of the present invention relate to a touch pen.

### 2. Discussion

A touch screen panel is an input device that allows a user's command to be input by selecting instructions displayed on a screen of an image display device or the like with a human finger or an object. Since the touch screen panel can replace separate input devices, such as a keyboard and a mouse, connected to the image display device, the use range of the touch screen panel is gradually expanded.

In general, when a user's finger or an object contacts a surface of the touch screen panel, the touch screen panel may recognize the touch in a capacitive manner that recognizes a contact position by detecting a change in capacitance.

On the other hand, the method in which the user's finger contacts the surface of the touch screen panel to recognize the touch may have a disadvantage in that the touch position cannot be recognized more precisely. In order to overcome this, research on touch pens (or stylus pens) has been actively conducted.

However, when the user applies pressure to the touch screen panel with a touch pen, if the pressure is applied to the touch screen panel beyond a limit pressure that the touch screen panel can withstand, the touch screen panel may be broken and/or the touch pen may be broken. Therefore, the development of a technology that can prevent the damage of the touch screen panel and the touch pen is needed.

### SUMMARY

According to an aspect of embodiments of the present invention, a touch pen capable of preventing or substantially preventing damage to a touch screen panel or the touch pen is provided.

However, aspects and objects of embodiments of the present invention are not limited to those mentioned above, and other technical aspects and objects not mentioned will be clearly understood by those skilled in the art from the following description.

According to one or more embodiments of the present invention, a touch pen for touching a display device to provide touch input information to the display device may include: a cover member; a touch member inside the cover member and including a touch tip, a coupling part, and a non-coupling part connecting the touch tip and the coupling part; and a holding member arranged to be fixed to an inner circumferential surface of the cover member and detachable from the coupling part according to a separation condition.

According to one or more embodiments, the holding member may be arranged to have a first distance from a center of the inside of the cover member to a first end of the holding member coupled with the inner circumferential surface of the cover member and a second distance from the center to a second end of the holding member. The touch member may have a third distance from the center to an outer circumferential surface of the touch member. The second distance may be equal to or less than the third distance.

According to one or more embodiments, the holding member may include: a first holding member at a first position of the inner circumferential surface of the cover member based on a cross-section of the inner circumferential surface of the cover member; and a second holding member at a second position different from the first position of the inner circumferential surface of the cover member based on the cross-section of the inner circumferential surface of the cover member.

According to one or more embodiments, the coupling part may include a coupling groove engaged with the holding member.

According to one or more embodiments, the coupling groove may have a shape corresponding to a shape of a second end of the holding member.

According to one or more embodiments, the holding member may include a first inclined surface and a second inclined surface arranged such that a width of the holding member becomes narrower from a first end end coupled with the inner circumferential surface of the cover member to the second end protruding toward the inside of the cover member, and the coupling groove may include a third inclined surface corresponding to the first inclined surface, and a fourth inclined surface corresponding to the second inclined surface.

According to one or more embodiments, the third inclined surface and the fourth inclined surface may be inclined surfaces of different angles.

According to one or more embodiments, the holding member may include: a support member detachable from the coupling part; and a first elastic member including a first side connected to the inner circumferential surface of the cover member and a second side connected to the support member.

According to one or more embodiments, the coupling part may include at least two protrusions detachable from the holding member.

According to one or more embodiments, the coupling part and the holding member may be coupled to each other by a magnetic force.

According to one or more embodiments, the coupling part may include any of a first magnetic member and a first metal member. The holding member may include any of a second magnetic member and a second metal member when the coupling part includes the first magnetic member, and the holding member may include the second magnetic member when the coupling part includes the first metal member.

According to one or more embodiments, the non-coupling part may include a nonmagnetic member.

According to one or more embodiments, the holding member may be separated from the coupling part when a force applied to the touch member satisfies the separation condition. The force applied to the touch member may correspond to a reaction force against pressure applied by the touch tip to a display device. The separation condition may be a condition that satisfies a case in which the reaction force is equal to or greater than a maximum static frictional force generated based on the magnetic force.

According to one or more embodiments, the coupling part and the non-coupling part may have different friction coefficients.

According to one or more embodiments, the friction coefficient of the coupling part may be greater than that of the non-coupling part.

According to one or more embodiments, the touch pen may further include a first button member including a first side connected to a second end of the touch member through a hole formed in a first end of the cover member, and configured to move the touch member based on a force applied from a second side of the first button member such that the touch member is coupled to the holding member when the touch member and the holding member are separated.

According to one or more embodiments, the touch pen may further include a second elastic member on an outer circumferential surface of the touch member, the second elastic member including a first side connected to a second end of the cover member and a second side connected to the non-coupling part, and configured to apply a force to the touch member when the coupling part and the holding member are coupled to each other.

According to one or more embodiments, the holding member may be separated from the coupling part when the force applied to the touch member satisfies the separation condition. The force applied to the touch member may correspond to a sum of a reaction force against a pressure applied by the touch tip to a display device and an elastic force of the second elastic member. The separation condition may be a condition that satisfies a case in which the sum is equal to or greater than a maximum static frictional force generated based on an elasticity of the holding member coupled to the coupling part.

According to one or more embodiments, the touch pen may further include a third elastic member including a first side connected to a first end of the cover member and a second side connected to a second side of the touch member, and configured to restore a position of the touch member such that the touch member is held by the holding member when the touch member and the holding member are separated.

According to one or more embodiments, the touch pen may further include: a fourth elastic member including a first side connected to a second side of the touch member; a second button member including a first side connected to a second side of the fourth elastic member; a plurality of fifth elastic members including a first side connected to a second side of the second button member; and a third button member including a first side connected to a second side of each of the fifth elastic members through a hole formed in a first end of the cover member, and configured to move the touch member based on a force applied from a second side of the third button member such that the touch member is held by the holding member when the touch member and the holding member are separated.

Further details of the above-described embodiments and other embodiments are included in the following detailed description and drawings.

### BRIEF DESCRIPTION OF THE DRAWINGS

The accompanying drawings, which are included to provide a further understanding of the inventive concepts, and are incorporated in and constitute a part of this specification, illustrate some example embodiments of the inventive concepts, and, together with the description, serve to explain principles of the inventive concepts.

FIG. 1 is a perspective view schematically illustrating a touch pen and a display device according to an embodiment of the present invention.

FIG. 2 is a cross-sectional view taken along the line I-I′ of FIG. 1.

FIG. 3 is a cross-sectional view schematically illustrating a touch member of FIG. 2.

FIGS. 4 and 5 are cross-sectional views taken along the line II-II′ of FIG. 1 to illustrate embodiments of a holding member.

FIG. 6 is a cross-sectional view for explaining an embodiment in which the touch member and the holding member are separated.

FIGS. 7 and 8 are enlarged views of a region “A” shown in FIG. 2 for explaining an embodiment of the touch member and a holding member.

FIGS. 9 and 10 are enlarged views of the region “A” shown in FIG. 2 for explaining some embodiments of the touch member and the holding member.

FIGS. 11 and 12 are enlarged views of the region “A” shown in FIG. 2 for explaining an embodiment of the touch member and the holding member.

FIG. 13 is an enlarged view of the region “A” shown in FIG. 2 for explaining an embodiment of the touch member and the holding member.

FIGS. 14 and 15 are enlarged views of the region “A” shown in FIG. 2 for explaining some embodiments of the touch member and the holding member.

FIG. 16 is an enlarged view of the region “A” shown in FIG. 2 for explaining an embodiment of the touch member and the holding member.

FIGS. 17 to 19 are cross-sectional views schematically illustrating embodiments of restoring a position of the touch member separated from the holding member.

FIG. 20 is a cross-sectional view schematically illustrating an embodiment of restoring the position of the touch member separated from the holding member.

FIG. 21 a cross-sectional view schematically illustrating an embodiment of restoring the position of the touch member separated from the holding member.

### DETAILED DESCRIPTION

Aspects and features of the present invention and a method for achieving them will become apparent with reference to some example embodiments described in further detail below together with the accompanying drawings. However, the present invention is not limited to the embodiments disclosed below, and may be implemented in various different forms. The embodiments of the present invention are provided so that the disclosure will be thorough and complete such that those skilled in the art to which the present invention pertains can fully understand the scope of the present invention. The present invention is defined by the scope of the claims.

In adding reference numerals to the elements of each drawing, the same elements may be given the same reference numerals as much as possible even though they are shown in different drawings. In addition, in describing the present invention, when it is determined that the detailed description of the known configuration or function may obscure the subject matter of the present invention, the detailed description thereof may be omitted.

In describing the elements of the invention, terms such as first, second, A, B, (a), and (b) may be used. These terms are used for the purpose of distinguishing one element from another element, and do not limit the nature, order, or number of the elements. In the embodiments, when elements are connected or coupled to each other, the elements may be not only directly connected or coupled to each other, but also another element or elements may be interposed therebetween or the elements may be connected or coupled through another element. In addition, when a first part, such as a component, an element, or a layer, is disposed on a second part, the first part may be not only directly on the second part, but also a third part or parts may be interposed therebetween. Further, singular forms are intended to include the plural forms as well, unless the context clearly indicates otherwise. It is to be further understood that the terms “comprise,” “include,” “have,” etc. when used in this specification, specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which example embodiments of the inventive concept belong. It is to be further understood that terms, such as those defined in commonly-used dictionaries, should be interpreted as having a meaning that is consistent with their meaning in the context of the relevant art and will not be interpreted in an idealized or overly formal sense unless expressly so defined herein.

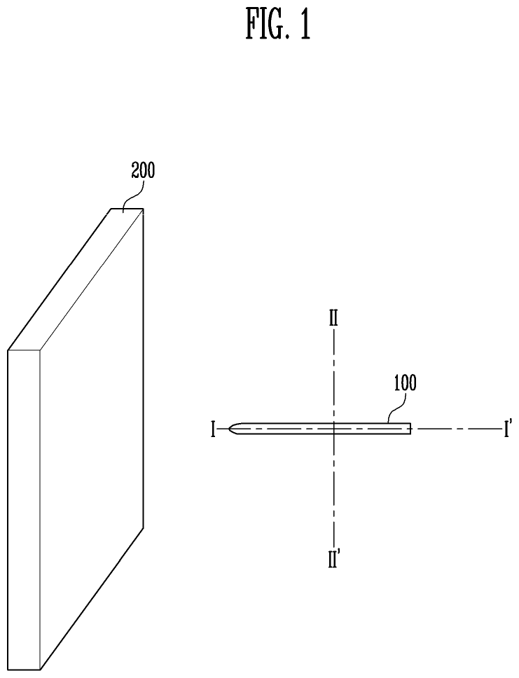

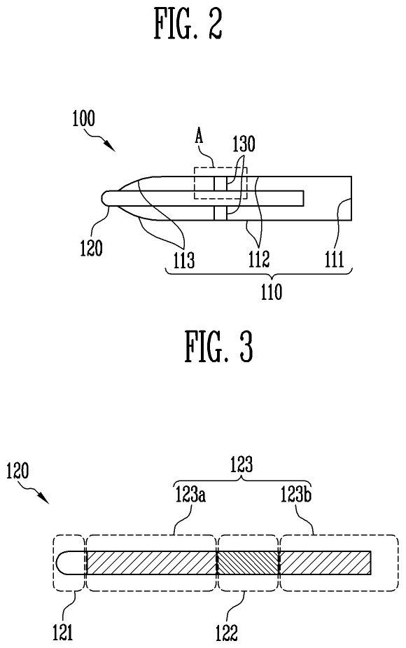

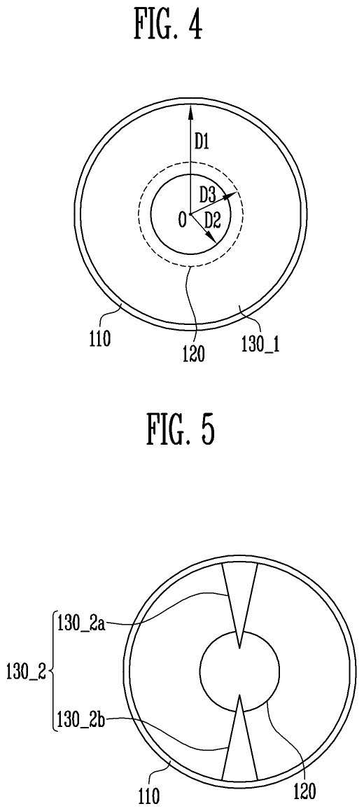

FIG. 1 is a perspective view schematically illustrating a touch pen 100 and a display device 200 according to an embodiment of the present invention; FIG. 2 is a cross-sectional view taken along the line I-I′ of FIG. 1; FIG. 3 is a cross-sectional view schematically illustrating a touch member 120 of FIG. 2; FIGS. 4 and 5 are cross-sectional views taken along the line II-II′ of FIG. 1 to illustrate embodiments of a holding member 130; and FIG. 6 is a cross-sectional view for explaining an embodiment in which the touch member 120 and the holding member 130 are separated.

Referring to FIG. 1, the touch pen 100 according to an embodiment of the present invention may be embodied as a stylus pen that touches a display device 200 to provide touch input information to a touch screen panel or a digitizer included in the display device 200. Here, the touch input information may include information about a position, intensity, and the like when the touch pen 100 touches the display device 200.

The touch pen 100 according to an embodiment of the present invention may be driven by any of various methods, such as an electromagnetic resonance (EMR) and an active electrostatic solution (AES).

The electromagnetic resonance method may refer to a method in which the touch pen 100 generates electromagnetic resonance by a magnetic field generated by the display device 200 such that a signal, such as coordinates of the touch pen 100, is provided to the display device 200. In further detail, when the touch screen panel or the digitizer included in the display device 200 generates the magnetic field, electromagnetic resonance occurs to the touch pen 100 within the magnetic field range, and, thus, energy may be supplied to the touch pen 100. In an embodiment, the touch pen 100 supplied with the energy may output a wireless signal through an internal circuit. In this case, the touch screen panel or the digitizer may measure the intensity by receiving the signal output from the touch pen 100 at various points, and calculate a position closest to the touch pen 100 based on the intensity to determine the position of the touch pen 100.

The active electrostatic solution method may refer to a method in which the touch screen panel or the digitizer detects static electricity generated by the touch pen 100 to sense coordinates, pressure, and the like of the touch pen 100.

The touch pen 100 may include a circuit and a coil for generating electromagnetic resonance, a pressure sensor for sensing the pressure of the touch pen 100 in contact with a panel, a printed circuit board (PCB), and the like.

As shown in FIG. 2, the touch pen 100 may include a cover member 110, a touch member 120, a holding member 130, and the like.

The cover member 110 may accommodate the touch member 120, the holding member 130, and the like. A user may support the touch pen 100 by gripping the cover member 110. The cover member 110 may include a first end 111, a main body 112, and a second end 113. The first end 111 of the cover member 110 may be closed or may be provided with a hole having a certain size (e.g., a predetermined size). The main body 112 of the cover member 110 may have a cylindrical shape having an outer circumferential surface and an inner circumferential surface such that the touch member 120 and the holding member 130 may be disposed therein. The second end 113 of the cover member 110 may be provided with a hole such that a portion of the touch member 120 may protrude outward. The cover member 110 may be made of a material such as any of a plastic and a non-metal member.

The touch member 120 may perform a function of touching a panel of the display device 200. The touch member 120 may be disposed inside the cover member 110. The portion of the touch member 120 may protrude out of the cover member 110. When a force applied from outside, for example, a pressure (e.g., a predetermined pressure) generated by contact between the touch pen 100 and the panel is applied to the touch member 120, the touch member 120 may be moved in a direction approaching the first end 111 of the cover member 110. Some example embodiments will be described later.

The holding member 130 may be coupled with the touch member 120 to fix the touch member 120. That is, one end (a first end) of the holding member 130 may be disposed to be fixed to the inner circumferential surface of the cover member 110, and the other end (a second end) of the holding member 130 may be coupled to a coupling part 122 of the touch member 120 shown in FIG. 3. The other end of the holding member 130 may be detachable from the touch member 120 shown in FIG. 3, and the other end of the separated holding member 130 may be positioned to correspond to a non-coupling part 123 shown in FIG. 3. In an embodiment, the holding member 130 may be implemented as a single member, such as of plastic, rubber, or the like having a relatively high elasticity, or may be implemented as a combination of two or more members including a spring and a support member, for example. Some example embodiments will be described later.

In an embodiment, the touch member 120 may be divided into various components depending on the intended use. Referring to FIG. 3, for example, the touch member 120 may include a touch tip 121, the coupling part 122, the non-coupling part 123, and the like.

The touch tip 121 may be a portion to be in contact with the panel of the display device 200, and may be formed at one end of the touch member 120. In an embodiment, the touch tip 121 may have a shape in which a diameter becomes narrower toward one end of the touch member 120, and since the diameter of one end of the touch member 120 may be sufficiently narrow, the user can more accurately touch a desired position on the panel.

The coupling part 122 may be a portion formed on the outer circumferential surface of the touch member 120 and coupled to the holding member 130. For example, the coupling part 122 may be coupled by the pressure of the other side of the holding member 130, may be coupled to engage with the shape of the other side of the holding member 130, or may be coupled by a magnetic force. However, embodiments of the present invention are not limited thereto. On the other hand, when the force applied from the outside to the touch tip 121 satisfies a separation condition (e.g., a predetermined separation condition), the coupling part 122 and the holding member 130 may be separated from each other. Some example embodiments will be described later.

The non-coupling part 123 may include other portions except for the coupling part 122 of the touch member 120. The non-coupling part 123 may be formed on the outer circumferential surface of the touch member 120 similarly to the coupling part 122, and may be a portion where the holding member 130 separated from the coupling part 122 is located. Further details thereof will be described later.

The holding member 130 coupled with the coupling part 122 may be implemented in various forms, such as an integrated type or a separate type.

Referring to FIGS. 2, 3 and 4, as an example, a holding member 130_1 may include an outer circumferential surface at a first distance D1 and an inner circumferential surface at a second distance D2, and, in an embodiment, may be integrally formed. In addition, the touch member 120 may include an outer circumferential surface at a third distance D3 and, in an embodiment, may be integrally formed. Here, the first distance D1, the second distance D2, and the third distance D3 may be distances measured from a center point O. In this case, the second distance D2 may be smaller than the third distance D3, and the third distance D3 may be smaller than the first distance D1.

In further detail, the holding member 130_1 may be configured as a donut-shaped member having the inner circumferential surface (or a second end) at the second distance D2 and the outer circumferential surface (or a first end) at the first distance D1. In addition, the touch member 120 may be configured as a cylindrical member having the outer circumferential surface at the third distance D3. In this case, the outer circumferential surface of the holding member 130_1 may be disposed to be fixed to the inner circumferential surface of the main body 112 of the cover member 110, and the inner circumferential surface of the holding member 130_1 may be inserted into and positioned inside the coupling part 122 included in the touch member 120. As a result, the holding member 130_1 and the touch member 120 may be coupled to each other. However, the shapes of the holding member 130_1 and the touch member 120 shown in FIG. 4 are merely examples for describing the coupling, and embodiments of the present invention are not limited to the shapes shown in FIG. 4.

Referring to FIGS. 2, 3, and 5, as another example, a holding member 130_2 may include a first holding member 130_2a disposed on an inner circumferential surface of the main body 112 of the cover member 110 and a second holding member 130_2b disposed at a position different from a position where the first holding member 130_2a is disposed, along the inner circumferential surface of the cover member 110.

In further detail, one end (a first end) of the first holding member 130_2a may be disposed to be fixed to the inner circumferential surface of the main body 112 of the cover member 110, and the other end (a second end) of the first holding member 130_2a may be inserted into and positioned inside the coupling part 122 included in the touch member 120. As a result, the first holding member 130_2a and the touch member 120 may be coupled to each other. Further, one end (a first end) of the second holding member 130_2b may be disposed to be fixed to the inner circumferential surface of the main body 112 of the cover member 110, and may be disposed at a position different from the position where the first holding member 130_2a is disposed, and the other end (a second end) of the holding member 130_2b may be inserted into and positioned inside the coupling part 122 included in the touch member 120. As a result, the second holding member 130_2b and the touch member 120 may be coupled to each other. The touch member 120 may include a groove formed in a portion where the coupling part 122 included in the touch member 120 and the first and second holding members 130_2a and 130_2b are coupled to each other.

In FIG. 5, the positions of the first holding member 130_2a and the second holding member 130_2b are shown symmetrically disposed on the inner circumferential surface of the main body 112 of the cover member 110; however, embodiments of the present invention are not limited thereto. For example, the first holding member 130_2a and the second holding member 130_2b may be disposed at arbitrary positions on the inner circumferential surface of the main body 112 of the cover member 110. In addition, the shapes of the first holding member 130_2a, the second holding member 130_2b, and the touch member 120 shown in FIG. 5 are merely examples for describing the coupling, and embodiments of the present invention are not limited to the shapes shown in FIG. 5. Herein, a plurality of holding members will be described as examples for convenience of description.

The user may continuously apply a force (e.g., a predetermined force) (or pressure) to the display device 200 by using the touch pen 100 according to an embodiment of the present invention. In this case, as a reaction against the force applied, a reaction force may act on the touch tip 121. If the touch member 120 and the holding member 130 are not separated from each other, the display device 200 or the touch tip 121 may be damaged by the reaction force continuously acting on the touch tip 121. Therefore, when a certain force (e.g., a predetermined force) is applied from the outside to the touch member 120, the touch member 120 according to an embodiment of the present invention can be moved within the cover member 110.

Referring to FIGS. 1, 2, 3, and 6, for example, when a force (e.g., a predetermined force) (or pressure) F₁ generated by contact between the touch pen 100 according to an embodiment of the present invention and the display device 200 is applied to the touch tip 121, and the force F₁ satisfies the separation condition (e.g., the predetermined separation condition), the holding member 130 and the coupling part 122 may be separated. In this case, the touch member 120 may be moved in a direction closer to the first end 111 of the cover member 110, and the holding member 130 may be positioned to correspond to the non-coupling part 123 as the touch member 120 is moved. Here, the separation condition may be a condition that satisfies a case, for example, in which the force F₁ acting on the touch tip 121 is greater than a maximum static friction force generated when the coupling part 122 and the holding member 130 are coupled (or contacted).

As described above, when the force F₁ is applied to the touch tip 121, since the coupling part 122 and the holding member 130 are separated, damage to the touch screen panel (or the digitizer) or the touch pen 100 may be effectively prevented.

Meanwhile, various methods for coupling between the touch member 120 and the holding member 130 exist. Herein, some embodiments of the method for coupling between the touch member 120 (specifically, the coupling part 122) and the holding member 130 will be described in further detail.

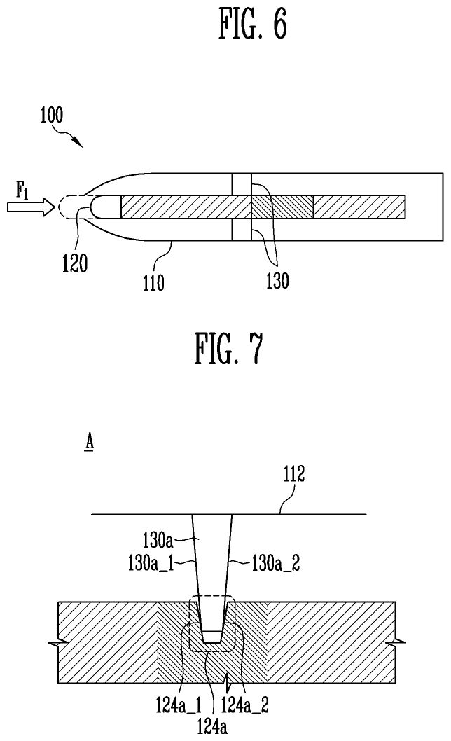

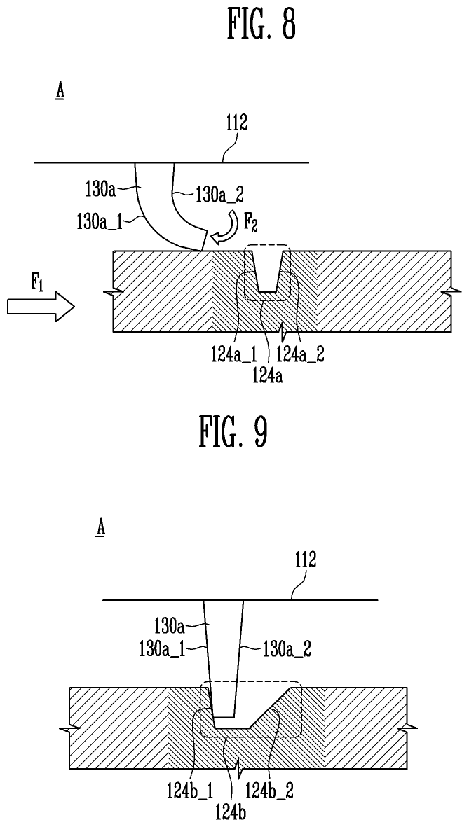

FIGS. 7 and 8 are enlarged views of a region “A” shown in FIG. 2 for explaining an embodiment of the touch member 120 and a holding member 130a.

Referring to FIGS. 2, 3, and 7, the coupling part 122 included in the touch pen 100 according to an embodiment of the present invention may include a first coupling groove 124a engaged with the other end (a second end) of the holding member 130a. Here, the first coupling groove 124a may have a shape corresponding to the shape of the other end of the holding member 130a.

In an embodiment, the holding member 130a may be made of a plastic having relatively high elasticity. However, embodiments of the present invention are not limited thereto. One end (a first end) of the holding member 130a may be coupled to the inner circumferential surface of the main body 112 of the cover member 110, and the other end of the holding member 130a may protrude toward the inside of the cover member 110.

In an embodiment, the holding member 130a may be configured to have a width narrowing from one end to the other end, and may have a first inclined surface 130a_1 and a second inclined surface 130a_2 that are gradually closer to each other toward the other end.

In an embodiment, the first coupling groove 124a may have a shape corresponding to the shape of the other end of the holding member 130a. The first coupling groove 124a may include a third inclined surface 124a_1 corresponding to the first inclined surface 130a_1, and a fourth inclined surface 124a_2 corresponding to the second inclined surface 130a_2. In an embodiment, the inclined direction of the first inclined surface 130a_1 may correspond to the inclined direction of the third inclined surface 124a_1, and the inclined direction of the second inclined surface 130a_2 may correspond to the inclined direction of the fourth inclined surface 124a_2. In an embodiment, the third inclined surface 124a_1 and the fourth inclined surface 124a_2 may be symmetrical with respect to a width direction of the touch member 120.

The other end of the holding member 130a is inserted into the first coupling groove 124a such that the holding member 130a and the touch member 120 may be coupled to each other. In this case, the first inclined surface 130a_1 of the holding member 130a and the third inclined surface 124a_1 of the first coupling groove 124a may be in contact with each other, and the second inclined surface 130a_2 of the holding member 130a and the fourth inclined surfaces 124a_2 of the first coupling groove 124a may be in contact with each other. In an embodiment, the first coupling groove 124a may be formed to have a depth such that the other end of the holding member 130a does not touch the bottom of the first coupling groove 124a. In another embodiment, the first coupling groove 124a may be formed to have a depth such that the other end of the holding member 130a contacts the bottom of the first coupling groove 124a.

In a state in which the holding member 130a and the first coupling groove 124a are coupled, when the force F₁ (for example, the reaction force against pressure applied to the touch screen panel or the digitizer) is applied from the outside to the touch tip 121, as shown in FIG. 6, the holding member 130a having the relatively high elasticity may be bent. In this case, an elastic force F₂ may be generated in the bent holding member 130a, and a maximum static friction coefficient due to the contact between the holding member 130a and the first coupling groove 124a and a maximum static friction force due to the elastic force F₂ may be generated. Here, when the number of the holding members 130a and the first coupling grooves 124a is plural, maximum static friction forces may be generated at the coupled portions of the holding members 130a and the first coupling grooves 124a, respectively.

Referring to FIGS. 2, 3, and 8, if the sum of the force F₁ applied from the outside and the elastic force F₂ (when the number of the holding members 130a is plural, the sum of the elastic forces F₂ generated in each of the holding members 130a) is greater than the maximum static friction force (when the number of the coupled portions of the holding members 130a and the first coupling grooves 124a is plural, the sum of maximum static frictional forces generated in each of the coupled portions), the touch member 120 may be moved as shown in FIG. 8, and the holding member 130a may be positioned at a first non-coupling part 123a in a bent state.

In an embodiment, a surface of the non-coupling part 123 may have a flat structure.

As described above, by using the holding member 130a having elasticity and the first coupling groove 124a, a detachable structure between the holding member 130a and the touch member 120 can be implemented relatively simply, thereby reducing manufacturing cost.

A limit pressure that the display device 200 can withstand may vary depending on the material (for example, plastic having flexibility, glass having rigidity) of a window of the display device 200. For example, a limit pressure of a flexible window (herein referred to as first limit pressure) may be much smaller than that of a rigid window (herein referred to as second limit pressure). Therefore, a coupling force between the holding member 130a and the touch member 120 may be adjusted according to the material.

To appropriately adjust the coupling force between the holding member 130a and the touch member 120 according to the material of the window, for example, some embodiments different from the embodiment shown in FIGS. 7 and 8 will be described below.

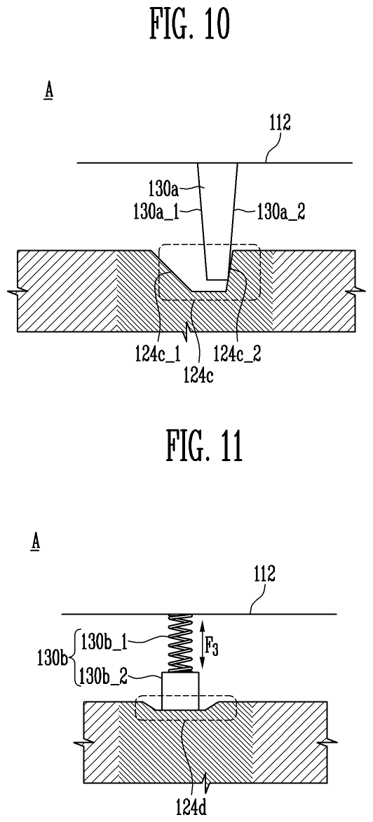

FIGS. 9 and 10 are enlarged views of the region “A” shown in FIG. 2 for explaining another embodiment of the touch member 120 and the holding member.

Referring to FIGS. 2, 3, 9, and 10, the holding member 130a shown in FIGS. 9 and 10 is the same as described above, and repeated description thereof will be omitted.

Similarly to the separation condition described with reference to FIGS. 7 and 8, in a separation condition in FIGS. 9 and 10, if the sum of the force applied to the touch tip 121 and elastic force (or the sum of elastic forces) of the holding member 130a is greater than the maximum static frictional force (or the sum of maximum static frictional forces) generated by the contact between the holding member 130a and coupling grooves 124b and 124c, the touch member 120 may be moved, and the holding member 130a may be positioned at the non-coupling part 123 (for example, the first non-coupling part 123a) in a bent state.

Similar to the first coupling groove 124a shown in FIGS. 7 and 8, a second coupling groove 124b shown in FIG. 9 and a third coupling groove 124c shown in FIG. 10 may have third inclined surfaces 124b_1 and 124c_1 and fourth inclined surfaces 124b_2 and 124c_2, respectively.

However, unlike the inclined surfaces 124a_1 and 124a_2 of the first coupling groove 124a, the third inclined surfaces 124b_1 and 124c_1 and the fourth inclined surfaces 124b_2 and 124c_2 respectively provided in the second coupling groove 124b and the third coupling groove 124c may be inclined surfaces having different angles. That is, the third inclined surfaces 124b_1 and 124c_1 and the fourth inclined surfaces 124b_2 and 124c_2 may have an asymmetric structure.

Referring to FIG. 9, as an example, in a case of the second coupling groove 124b, an inclination degree of the third inclined surface 124b_1 may be smaller than that of the fourth inclined surface 124b_2 based on a direction in which the holding member 130a extends (from one end to the other end).

Referring to FIG. 10, as another example, in a case of the third coupling groove 124c, an inclination degree of the third inclined surface 124c_1 may be greater than that of the fourth inclined surface 124c_2 based on the direction in which the holding member 130a extends (from one end to the other end).

When the coupling force (herein referred to as first coupling force) between the holding member 130a and the touch member 120 according to the embodiment shown in FIG. 9, the coupling force (herein referred to as second coupling force) between the holding member 130a and touch member 120 according to the embodiment shown in FIG. 10, the first limit pressure, and the second limit pressure are compared and listed in the order of magnitude, in general, they may be in the order of the second limit pressure, the second coupling force, the first limit pressure and the first coupling force (that is, the second limit pressure the second coupling force the first limit pressure the first coupling force).

Therefore, according to the embodiment shown in FIGS. 2, 3, and 9, damage to the flexible window and the touch pen 100 can be prevented or substantially prevented, and, according to the embodiment shown in FIGS. 2, 3, and 10, damage to the rigid window and the touch pen 100 can be prevented or substantially prevented. In addition, malfunction in the separation process between the touch member 120 and the holding member 130a may be prevented.

To increase the coupling force between the holding member 130a and the touch member 120, an embodiment different from the embodiments shown in FIGS. 7 to 10 will be described below.

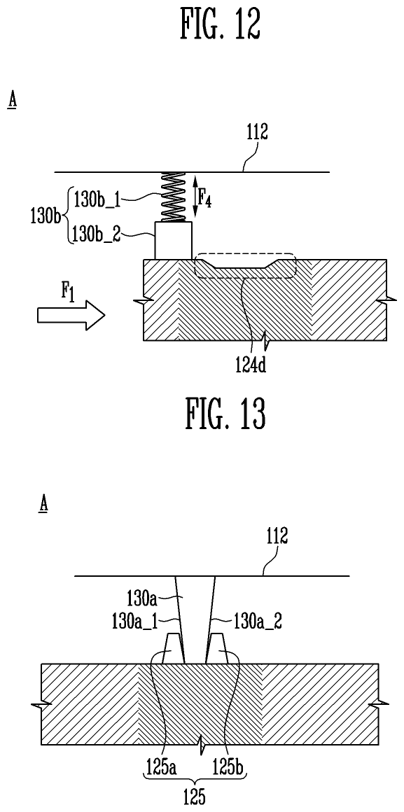

FIGS. 11 and 12 are enlarged views of the region “A” shown in FIG. 2 for explaining another embodiment of the touch member 120 and a holding member 130b.

Referring to FIGS. 2, 3, and 11, the holding member 130b may include a first elastic member 130b_1 and a support member 130b_2.

The first elastic member 130b_1 may be in a compressed state inside the cover member 110. The first elastic member 130b_1 may apply an elastic force to each of the inner circumferential surface of the main body 112 of the cover member 110 and the support member 130b_2. One end (a first end) of the first elastic member 130b_1 may be connected to the inner circumferential surface of the main body 112 of the cover member 110, and the other end (a second end) of the first elastic member 130b_1 may be connected to the support member 130b_2. In an embodiment, the first elastic member 130b_1 may be implemented as a spring, but embodiments of the present invention are not limited thereto.

The support member 130b_2 may be in contact with or coupled to the coupling part 122, and may be separated from the coupling part 122 when the force applied to the touch member 120 satisfies the separation condition. For example, the support member 130b_2 may be in contact with a fourth coupling groove 124d or separated from the fourth coupling groove 124d to be positioned in the first non-coupling part 123a or a second non-coupling part 123b. In an embodiment, the shape of the support member 130b_2 may be a quadrangular shape as shown in FIGS. 11 and 12, but embodiments of the present invention are not limited thereto.

The coupling part 122 may have the fourth coupling groove 124d. Here, the fourth coupling groove 124d may have inclined surfaces similar to the first to third coupling grooves 124a, 124b, and 124c. However, the shapes of the inclined surfaces provided in the fourth coupling groove 124d may be different from those of the inclined surfaces 124a_1, 124a_2, 124b_1, 124b_2, 124c_1, and 124c_2 provided in the first to third coupling grooves 124a, 124b, and 124c, respectively. This may prevent the elastic force of the first elastic member 130b_1 coupling the holding member 130b and the touch member 120 from being excessively reduced.

In an embodiment, to prevent the elastic force of the first elastic member 130b_1 from being excessively reduced, the fourth coupling groove 124d may be formed to have a depth shallower than that of each of the first to third coupling grooves 124a, 124b, and 124c.

When the holding member 130b and the fourth coupling groove 124d are coupled to each other, a normal force may be generated according to an elastic force F₃ of the first elastic member 130b_1 in a surface where the support member 130b_2 and the fourth coupling groove 124d are in contact with each other. In this case, when the force F₁ (for example, the reaction force against the pressure applied to the touch screen panel or the digitizer) is applied from the outside to the touch tip 121, a maximum static friction coefficient due to the contact between the support member 130b_2 and the fourth coupling groove 124d and a maximum static friction force due to the normal force may be generated. Here, when the number of the holding members 130b and the fourth coupling grooves 124d is plural, maximum static friction forces may be generated at the coupled portions of the support members 130b_2 and the fourth coupling grooves 124d, respectively.

Referring to FIGS. 3 and 12, if the force F₁ applied from the outside is greater than the maximum static frictional force (when the number of coupled portions between the support members 130b_2 and the fourth coupling grooves is plural, the sum of maximum static frictional forces generated in each of the coupled portions), the touch member 120 may be moved as shown in FIG. 12, the first elastic member 130b_1 may be further compressed, and the holding member 130b may be positioned at the non-coupling part 123 (for example, the first non-coupling part 123a). In this case, an elastic force F₄ of the first elastic member 130b_1 may act on the first non-coupling part 123a.

In an embodiment, the surface of the non-coupling part 123 may have a flat structure as described above.

As described above, by implementing the holding member 130b as the support member 130b_2 and the first elastic member 130b_1, the coupling force between the holding member 130b and the touch member 120 can be increased, and a malfunction in the separation process between the touch member 120 and the holding member 130b may be prevented or substantially prevented.

Another embodiment of the touch member 120 and the holding member will be described below.

FIG. 13 is an enlarged view of the region “A” shown in FIG. 2 for explaining another embodiment of the touch member 120 and the holding member 130a.

Referring to FIGS. 2, 3, and 13, the coupling part 122 may further include at least one protrusion 125 detachable from the holding member 130a. In an embodiment, the coupling part 122 includes two protrusions 125 that are detachable from the holding member 130a, but embodiments are not limited thereto. When the holding member 130a is positioned between a first protrusion 125a and a second protrusion 125b, the holding member 130a and the touch member 120 may be maintained in a coupled state.

Similar to the above, when the force is applied from the outside to the touch tip 121, the holding member 130a may be bent to generate an elastic force (e.g., a predetermined elastic force). In addition, a maximum static friction coefficient due to the contact between the holding member 130a and the protrusions 125 and a maximum static friction force due to the elastic force may be generated. When the sum of the force applied from the outside and the elastic force is greater than the maximum static frictional force, the holding member 130a may be detached between the protrusions 125, and the holding member 130a and the touch member 120 may be separated.

In an embodiment, the holding member 130a shown in FIG. 13 is the same as that shown in FIGS. 7 to 10, but embodiments of the present invention are not limited thereto. For example, the holding member 130b shown in FIGS. 11 and 12 may also be applied to the embodiment shown in FIG. 13.

According to the above, by implementing the holding members 130a and 130b as the support member 130b_2 and the first elastic member 130b_1, the coupling force between the holding members 130a and 130b and the touch member 120 can be increased, and a malfunction in the separation process between the touch member 120 and the holding members 130a and 130b may be prevented or substantially prevented.

To further increase the coupling force between the holding members 130a and 130b and the touch member 120, an embodiment different from the embodiments shown in FIGS. 7 to 13 will be described below.

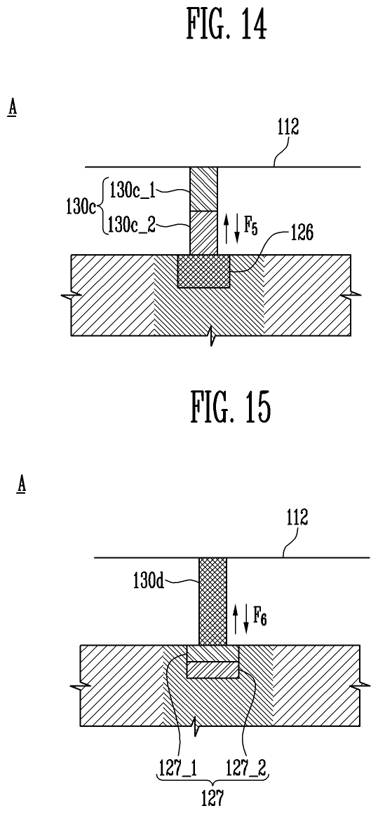

FIGS. 14 and 15 are enlarged views of the region “A” shown in FIG. 2 for explaining another embodiment of the touch member 120 and holding members 130c and 130d.

Referring to FIGS. 2, 3, 14, and 15, the coupling part 122 and the holding members 130c and 130d may be coupled by magnetic forces F₅ and F₆. In an embodiment, at least one of the coupling part 122 and the holding members 130c and 130d may be a magnetic member. In an embodiment, the coupling part 122 may be any one of a magnetic member and a metal member. When the coupling part 122 is the magnetic member, the holding members 130c and 130d may be either a magnetic member or a metal member, and when the coupling part 122 is the metal member, the holding members 130c and 130d may be a magnetic member. Here, the magnetic member may mean a member having magnetism, such as a magnet, and the metal member may mean a member such as gold, silver, copper, and the like, which can be coupled to the magnetic member by the magnetic force.

Referring to FIGS. 2 and 14, as an example, the holding member 130c may be a magnetic member having a first pole 130c_1 and a second pole 130c_2, and the coupling part 122 may include a metal member 126. One end (a first end) of the first pole 130c_1 may be disposed to be fixed to the inner circumferential surface of the main body 112 of the cover member 110, and the other end (a second end) of the second pole 130c_2 may be in contact with a surface of the metal member 126. Here, the first pole 130c_1 may be, for example, one of an N pole or an S pole, and the second pole 130c_2 may have a polarity opposite to the first pole 130c_1. In this case, since the magnetic force is generated between the other end of the second pole 130c_2 and the surface of the metal member 126, the holding member 130c and the coupling part 122 may be coupled to each other by the magnetic force F₅. When the magnetic force F₅ is generated, a normal force due to the magnetic force F₅ may be generated at the contact surface of the other end of the second pole 130c_2 and the surface of the metal member 126. In addition, a maximum static friction coefficient due to the contact between the other end of the second pole 130c_2 and the surface of the metal member 126 and the maximum static friction force (or the sum of maximum static friction forces) due to the normal force may be generated.

In an embodiment, in FIG. 14, the entire holding member 130c is made of the magnetic member, and the metal member 126 provided in the coupling part 122 may be partially disposed in the coupling part 122; however, embodiments of the present invention are not limited to this. In an embodiment, for example, the magnetic member may be partially provided at the other end of the holding member 130c, and the entire coupling part 122 may be made of the metal member 126.

Referring to FIGS. 2 and 15, as another example, the holding member 130d may be the metal member, and the coupling part 122 may include a magnetic member 127 having a first pole 127_1 and a second pole 127_2. One end (a first end) of the holding member 130d may be disposed to be fixed to the inner circumferential surface of the main body 112 of the cover member 110, and the other end (a second end) of the holding member 130d may be in contact with the first pole 127_1. In this case, since the magnetic force F₆ is generated between the other end of the holding member 130d and the first pole 127_1, the holding member 130d and the coupling part 122 may be coupled to each other by the magnetic force F₆. When the magnetic force F₆ is generated, a normal force due to the magnetic force F₆ may be generated at the contact surface between the other end of the holding member 130d and the first pole 127_1. In addition, a maximum static friction coefficient due to the contact between the other end of the holding member 130d and the first pole 127_1 and the maximum static friction force (or the sum of maximum static friction forces) due to the normal force may be generated.

In an embodiment, as shown in FIG. 15, the entire holding member 130d is made of the metal member, and the magnetic member 127 may be partially disposed within the coupling part 122, but embodiments of the present invention are not limited to this. In an embodiment, for example, the metal member may be partially provided only at the other end of the holding member 130d, and the entire coupling portion 122 may be made of the magnetic member 127.

In an embodiment, although not shown, the holding member 130 and the coupling part 122 may both be the magnetic members. In this case, the holding member 130 and the coupling part 122 may have opposite polarities and may be disposed to face each other such that an attractive force can be generated.

The holding member 130c or 130d may be separated from the coupling part 122 when the force applied to the touch member 120 satisfies the separation condition (e.g., the predetermined separation condition). In this case, the force (for example, F₁) applied to the touch member 120 may correspond to the reaction force against pressure applied by the touch tip 121 to the touch screen panel (or the digitizer). The separation condition may be a condition that satisfies a case in which the reaction force is greater than or equal to the maximum static friction force generated based on the magnetic force F₅ or F₆.

The non-coupling part 123 may be a nonmagnetic member such that a degree of separation between the touch member 120 and the holding member 130c or 130d becomes clearer.

As described above, the coupling force between the holding member 130c or 130d and the touch member 120 may be increased by using the magnetic force F₅ or F₆, and a malfunction in the separation process between the touch member 120 and the holding member 130c or 130d may be prevented or substantially prevented.

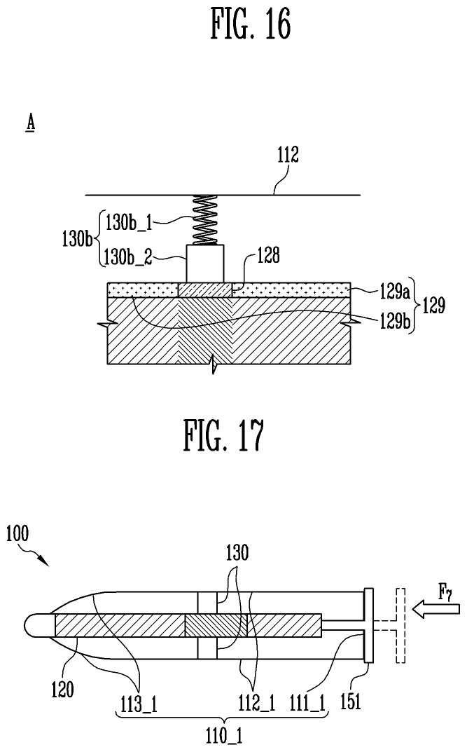

FIG. 16 is an enlarged view of the region “A” shown in FIG. 2 for explaining another embodiment of the touch member 120 and the holding member 130b.

Referring to FIGS. 3 and 16, the coupling part 122 and the non-coupling part 123 may have different friction coefficients. In this case, the friction coefficient of a first surface 128 of the coupling part 122 may be greater than that of a second surface 129 of the non-coupling part 123. Here, the friction coefficient may mean a maximum static friction coefficient. Here, as the difference between the friction coefficient of the first surface 128 and the friction coefficient of the second surface 129 increases, the coupling structure or the separation structure between the holding member 130b and the touch member 120 may be clearly distinguished. That is, as the friction coefficient of the first surface 128 becomes larger than the friction coefficient of the second surface 129, the coupling structure or the separation structure between the holding member 130b and the touch member 120 may be more clearly distinguished.

In an embodiment, the holding member 130b shown in FIG. 16 is the same as that shown in FIGS. 11 and 12, but embodiments of the present invention are not limited thereto. For example, the holding member 130a shown in FIGS. 7 to 10 may also be applied.

Referring to FIGS. 11 and 12, similar to the above, a normal force may be generated by the contact between the holding member 130b and the first surface 128 of the coupling part 122. In addition, a friction coefficient (for example, a maximum static friction coefficient) due to the contact between the holding member 130b and the first surface 128 of the coupling part 122 and the maximum static friction force due to the normal force may be generated. In this case, when the reaction force against the pressure applied by the touch tip 121 to the touch screen panel (or the digitizer) is greater than the maximum static friction force, the holding member 130b and the touch member 120 may be separated. That is, the holding member 130b in contact with the coupling part 122 may be positioned at the non-coupling part 123 due to the movement of the touch member 120.

As described above, by using the coupling part 122 and the non-coupling part 123 having different friction coefficients, the coupling operation or the separation operation between the touch member 120 and the holding member 130b can be implemented, thereby reducing a manufacturing cost.

In a state in which the touch member 120 and the holding member 130b are separated, it may be difficult for a user to provide the touch input information to the touch screen panel (or the digitizer) by touching the display device 200 using the touch pen 100. In this case, it is necessary to restore the position of the touch member 120. Herein, an embodiment of restoring the position of the touch member 120 separated from the holding member 130b will be described in further detail.

FIGS. 17 to 19 are cross-sectional views schematically illustrating some embodiments of restoring a position of the touch member 120 separated from the holding member 130.

Referring to FIGS. 17 to 19, the touch pen 100 according to an embodiment of the present invention may include a cover member 110_1 and may further include a first button member 151.

Here, the cover member 110_1 shown in FIGS. 17 to 19 may be composed of a first end 111_1, a main body 112_1, and a second end 113_1, similar to the cover member 110 shown in FIGS. 1 to 16. In an embodiment, the main body 112_1 and the second end 113_1 of the cover member 110_1 shown in FIGS. 17 to 19 may be the same as those shown in FIGS. 1 to 16. However, unlike the cover member 110 shown in FIGS. 1 to 16, the cover member 110_1 shown in FIGS. 17 to 19 may include a hole formed in the first end 111_1.

The first button member 151 may restore the position of the separated touch member 120. When the touch member 120 and the holding member 130 are separated, the first button member 151 may move the touch member 120 based on a force F₇ applied from the outside such that the touch member 120 can be coupled with the holding member 130 again. In an embodiment, the first button member 151 may be implemented as a non-metal member, such as a plastic or rubber.

One side (a first side) of the first button member 151 may be connected to the other end of the touch member 120 through the first end 111_1 of the cover member 110_1. When the hole is formed in the first end 111_1, the one side of the first button member 151 may be coupled to the second non-coupling part 123b (refer to FIG. 3) of the touch member 120 through the hole formed in the first end 111_1. In an embodiment, the other side (a second side) of the first button member 151 may be formed as a flat surface such that a user can easily press it.

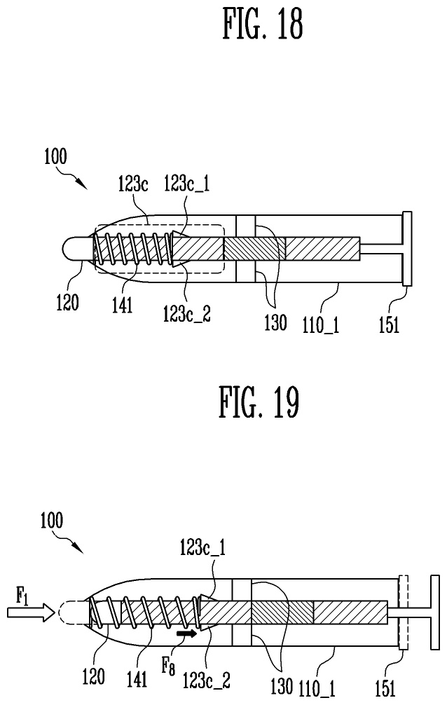

As shown in FIG. 18, the touch pen 100 according to an embodiment of the present invention may further include a second elastic member 141.

The second elastic member 141 may be a member having a relatively high elasticity, such as a spring. When the coupling part 122 (refer to FIG. 3) and the holding member 130 are coupled, an elastic force may be generated on the touch member 120, and the force may be applied to the touch member 120, such that the touch member 120 and the holding member 130 can be easily separated.

The second elastic member 141 may be disposed on the outer circumferential surface of the touch member 120. One side (a first side) of the second elastic member 141 may be connected to the second end 113_1 of the cover member 110_1, and the other side (a second side) of the second elastic member 141 may be connected to the non-coupling part 123. Here, the non-coupling part 123 may include support protrusions 123c_1 and 123c_2 on the outer circumferential surface to be connected to the second elastic member 141.

For example, one side of the second elastic member 141 may be disposed to be fixed to the second end 113_1, and the other side of the second elastic member 141 may be disposed to be fixed to each of the first support protrusion 123c_1 and the second support protrusion 123c_2. By the elasticity of the second elastic member 141, a force may be applied to each of the second end 113_1 and the first and second support protrusions 123c_1 and 123c_2.

As shown in FIG. 19, when a force applied to the touch member 120 satisfies the separation condition (e.g., the predetermined separation condition), the holding member 130 may be separated from the coupling part 122. In this case, the force applied to the touch member 120 may correspond to the sum of the reaction force F₁ against the pressure applied by the touch tip 121 to the touch screen panel (or the digitizer) and an elastic force F₈ of the second elastic member 141. The separation condition may be a condition that satisfies a case in which the sum is equal to or greater than the maximum static frictional force generated by the coupling of the holding member 130 and the coupling part 122.

As described above, since the position of the separated touch member 120 is restored, convenience may be provided to the user.

Herein, an embodiment in which a user restores the position of the touch member 120 without separately applying a force will be described in further detail.

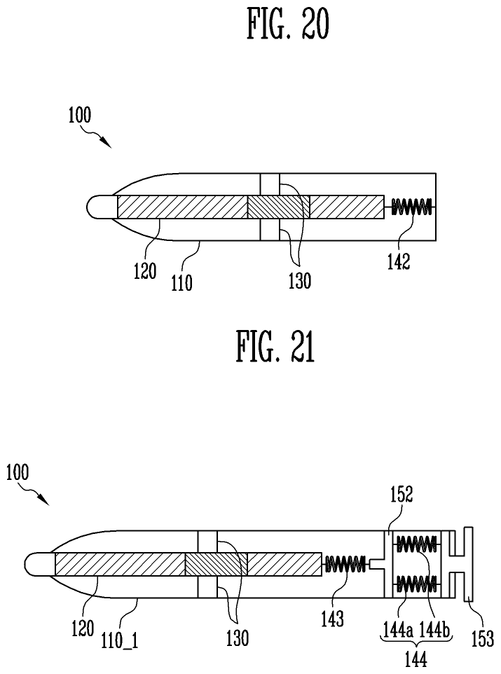

FIG. 20 is a cross-sectional view schematically illustrating another embodiment of restoring the position of the touch member 120 separated from the holding member.

Referring to FIG. 20, the touch pen 100 according to an embodiment of the present invention may further include a third elastic member 142.

The third elastic member 142 may be a member having a relatively high elasticity, such as a spring. When the touch member 120 and the holding member 130 are separated, the position of the touch member 120 may be restored such that the touch member 120 may be held by the holding member 130.

One side (a first side) of the third elastic member 142 may be connected to the first end 111 of the cover member 110, and the other side (a second side) of the third elastic member 142 may be connected to the other side of the touch member 120. The one side of the third elastic member 142 may be coupled to the first end 111 of the cover member 110, and the other side of the third elastic member 142 may be connected to the second non-coupling part 123b (refer to FIG. 3) of the touch member 120. The one side and the other side of the third elastic member 142 may be fixed.

Although not shown, when the force applied to the touch tip 121 satisfies the separation condition, and the touch member 120 and the holding member 130 are separated, the third elastic member 142 may be compressed. If the force applied to the touch tip 121 no longer satisfies the separation condition, the touch member 120 may be moved by the elastic force generated by the compressed third elastic member 142, and the touch member 120 coupled with the third elastic member 142 may return to its original position and may be held by the holding member 130.

As described above, since the position of the touch member 120 is restored without the user applying a separate force, convenience may be provided to the user.

FIG. 21 a cross-sectional view schematically illustrating another embodiment of restoring the position of the touch member 120 separated from the holding member 130.

Referring to FIG. 21, the touch pen 100 according to an embodiment of the present invention may include the cover member 110_1 shown in FIGS. 17 to 19, and may further include a fourth elastic member 143, a second button member 152, a fifth elastic member 144, and a third button member 153.

The fourth elastic member 143 may be a member having a relatively high elasticity, such as a spring. One side (a first side) of the fourth elastic member 143 may be connected to the other side (a second side) (for example, the second non-coupling part 123b of FIG. 3) of the touch member 120, and the other side (a second side) of the fourth elastic member 143 may be connected to one side (a first side) of the second button member 152.

The second button member 152 may be disposed inside the cover member 110_1 to support the fourth elastic member 143 and the fifth elastic member 144, and may be movable. One side of the second button member 152 may be connected to the other side of the fourth elastic member 143, and the other side (a second side) of the second button member 152 may be connected to one side (a first side) of the fifth elastic member 144.

The fifth elastic member 144 may be a member having a relatively high elasticity, such as a spring. One side of the fifth elastic member 144 may be connected to the other side of the second button member 152, and the other side (a second side) of the fifth elastic member 144 may be connected to one side (a first side) of the third button member 153. In an embodiment, a number of the fifth elastic members 144 may be plural.

Similar to the first button member 151, when the touch member 120 and the holding member 130 are separated, the third button member 153 may move the touch member 120 based on a force applied from the other side such that the touch member 120 may be held by the holding member 130. The one side of the third button member 153 may be connected to the other side of each of the fifth elastic members 144 through the hole formed in the first end 111_1 shown in FIG. 17.

Similar to the above, when a user applies a force to the third button member 153 in a state in which the touch member 120 and the holding member 130 are separated, the separated touch member 120 may return to the original position, and may be held by the holding member 130.

As described above, embodiments of the present invention may provide the touch pen capable of preventing or substantially preventing damage to the touch screen panel or the touch pen.

The aspects and effects according to the embodiments are not limited by the contents described above, and further various aspects and effects are included in the present specification.

Although some example embodiments of the present invention have been described with reference to the accompanying drawings, it will be understood by those skilled in the art to which the disclosure pertains that the embodiments may be implemented in other specific forms without changing the technical spirit and essential features of the disclosure. Therefore, it should be understood that the embodiments described above are illustrative and are not restrictive in all aspects.

What is claimed is:

1. A touch pen for touching a display device to provide touch input information to the display device, the touch pen comprising:
a cover member;
a touch member inside the cover member and comprising a touch tip, a coupling part, and a non-coupling part connecting the touch tip and the coupling part; and
a holding member arranged to be fixed to an inner circumferential surface of the cover member and detachable from the coupling part according to a separation condition.

2. The touch pen of claim 1, wherein the holding member is arranged to have a first distance from a center of the inside of the cover member to a first end of the holding member coupled with the inner circumferential surface of the cover member and a second distance from the center to a second end of the holding member,
wherein the touch member has a third distance from the center to an outer circumferential surface of the touch member, and
wherein the second distance is equal to or less than the third distance.

3. The touch pen of claim 1, wherein the holding member comprises:
a first holding member at a first position of the inner circumferential surface of the cover member based on a cross-section of the inner circumferential surface of the cover member; and
a second holding member at a second position different from the first position of the inner circumferential surface of the cover member based on the cross-section of the inner circumferential surface of the cover member.

4. The touch pen of claim 1, wherein the coupling part comprises a coupling groove engaged with the holding member.

5. The touch pen of claim 4, wherein the coupling groove has a shape corresponding to a shape of a second end of the holding member.

6. The touch pen of claim 5, wherein the holding member comprises a first inclined surface and a second inclined surface arranged such that a width of the holding member becomes narrower from a first end coupled with the inner circumferential surface of the cover member to the second end protruding toward the inside of the cover member, and
wherein the coupling groove comprises a third inclined surface corresponding to the first inclined surface, and a fourth inclined surface corresponding to the second inclined surface.

7. The touch pen of claim 6, wherein the third inclined surface and the fourth inclined surface are inclined surfaces of different angles.

8. The touch pen of claim 1, wherein the holding member comprises:
a support member detachable from the coupling part; and
a first elastic member comprising a first side connected to the inner circumferential surface of the cover member and a second side connected to the support member.

9. The touch pen of claim 1, wherein the coupling part comprises at least two protrusions detachable from the holding member.

10. The touch pen of claim 1, wherein the coupling part and the holding member are coupled to each other by a magnetic force.

11. The touch pen of claim 10, wherein the coupling part comprises any of a first magnetic member and a first metal member,
wherein the holding member comprises any of a second magnetic member and a second metal member when the coupling part comprises the first magnetic member, and
wherein the holding member comprises the second magnetic member when the coupling part comprises the first metal member.

12. The touch pen of claim 11, wherein the non-coupling part comprises a nonmagnetic member.

13. The touch pen of claim 10, wherein the holding member is separated from the coupling part when a force applied to the touch member satisfies the separation condition,
wherein the force applied to the touch member corresponds to a reaction force against pressure applied by the touch tip to a display device,
wherein the separation condition is a condition that satisfies a case in which the reaction force is equal to or greater than a maximum static frictional force generated based on the magnetic force.

14. The touch pen of claim 1, wherein the coupling part and the non-coupling part have different friction coefficients.

15. The touch pen of claim 14, wherein the friction coefficient of the coupling part is greater than that of the non-coupling part.

16. The touch pen of claim 1, further comprising a first button member comprising a first side connected to a second end of the touch member through a hole formed in a first end of the cover member, and configured to move the touch member based on a force applied from a second side of the first button member such that the touch member is coupled to the holding member when the touch member and the holding member are separated.

17. The touch pen of claim 16, further comprising a second elastic member on an outer circumferential surface of the touch member, the second elastic member comprising a first side connected to a second end of the cover member and a second side connected to the non-coupling part, and configured to apply a force to the touch member when the coupling part and the holding member are coupled to each other.

18. The touch pen of claim 17, wherein the holding member is separated from the coupling part when the force applied to the touch member satisfies the separation condition,
wherein the force applied to the touch member corresponds to a sum of a reaction force against a pressure applied by the touch tip to a display device and an elastic force of the second elastic member, and
wherein the separation condition is a condition that satisfies a case in which the sum is equal to or greater than a maximum static frictional force generated based on an elasticity of the holding member coupled to the coupling part.

19. The touch pen of claim 1, further comprising a third elastic member comprising a first side connected to a first end of the cover member and a second side connected to a second side of the touch member, and configured to restore a position of the touch member such that the touch member is held by the holding member when the touch member and the holding member are separated.

20. The touch pen of claim 1, further comprising:
a fourth elastic member comprising a first side connected to a second side of the touch member;
a second button member comprising a first side connected to a second side of the fourth elastic member;
a plurality of fifth elastic members comprising a first side connected to a second side of the second button member; and
a third button member comprising a first side connected to a second side of each of the fifth elastic members through a hole formed in a first end of the cover member, and configured to move the touch member based on a force applied from a second side of the third button member such that the touch member is held by the holding member when the touch member and the holding member are separated.
